(19) United States
(12) Patent Application Publication
(10) Pub. No.: US 2013/0101878 A1
(43) Pub. Date: Apr. 25, 2013

(54) BATTERY COMPRISING CUBOID CELLS WHICH CONTAIN A BIPOLAR ELECTRODE

(71) Applicants: Peter Pilgram, Ingolstadt (DE); Henrik Hahn, Dresden (DE); Ernst Robert Barenschee, Nidderau (DE)

(72) Inventors: Peter Pilgram, Ingolstadt (DE); Henrik Hahn, Dresden (DE); Ernst Robert Barenschee, Nidderau (DE)

(73) Assignee: Evonik Litarion GmbH, Kamenz (DE)

(21) Appl. No.: 13/703,914

(22) PCT Filed: Jul. 18, 2011
(86) PCT No.: PCT/EP2011/062208

§ 371 Date: Dec. 13, 2012

(30) Foreign Application Priority Data
Jul. 20, 2010 (DE) 102010031543.5

(51) Int. Cl. H01M 2/20; H01M 4/66

(52) U.S. Cl. CPC H01M 2/20; H01M 4/661
USPC 429/99

(57) ABSTRACT

The invention relates to a battery (0), comprising a plurality of self-contained, substantially cuboid cell housings (1), in each of which a side face is formed at least in some regions as a negative pole (−) and the opposite side face is designed at least in some regions as a positive pole (+), wherein the cell housings (1) bear against one another, with the pole (−) on the pole (+), and extend between a positive contact (14) and a negative contact (13), and wherein the cell housings (1) are each enclosed by an electrically non-conductive, mechanically supporting frame (2). The aim of the invention is to provide such a battery which has lower internal resistance and is therefore suitable for applications which require rapid charging or discharging (high-power applications). Said aim is achieved by at least one flat bimetal element (7) which is formed of copper and aluminium and is coated with active anode material (9) on the copper side and with active cathode material (8) on the aluminium side and which extends within one of the cell housings (1) parallel to the poles (+), (−) thereof, and is attached to the frame (2) of the cell housing (1) so as to provide ionic sealing and the cell housing (1) is thus divided into at least two series-connected galvanic cells.

The invention relates to a battery having a plurality of intrinsically closed, essentially cuboidal cell housings in which in each case one side face is at least partly configured as negative pole and the opposite side face is at least partly configured as positive pole, where the cell housings are in juxtaposition pole to pole and extend between a positive contact and a negative contact and the cell housings are bounded in each case by an electrically nonconductive, mechanically supporting frame.

Such a battery is known from WO 2009/103527 A1.

For the purposes of the present invention, an electrochemical cell is a device for converting chemical energy into electric energy. It is formed by a space which is filled with an ion-conducting electrolyte and in which an anode and a cathode are arranged. The electrolyte is retained in the space so that ions cannot leave the space. The anode and the cathode can be made up of a plurality of parts. To prevent short circuits between anode and cathode, an ionically conductive, electrically insulating separator can be arranged between the electrodes.

Active material is, in the sense used here, a material which is able to incorporate and release ions. Anodically active material forms the anode, cathodically active material forms the cathode. Counter-active material of anodically active material is cathodically active material; counter-active material of cathodically active material is anodically active material.

At least two electrochemical cells which are electrically connected to one another form a battery.

The term cell housing used here refers to a mechanical assembly which comprises at least one electrochemical cell.

WO 2009/103527 A1 describes the structure of a high-voltage secondary lithium ion battery suitable for uses in vehicles. Here, each cell housing accommodates precisely one electrochemical cell; in order to increase the capacity of a single cell, a plurality of electrode foils of the same polarity are electrically connected therein via power outlet tabs. The voltage between the poles of the cell housings is thus determined directly by the choice of the active materials; in the case of the Li ion embodiment mentioned by way of example, a cell voltage of 3.6 V per cell housing is to be expected. Within the battery presented, 30 cell housings are connected in series so that the battery voltage is about 108 V.

Such a battery is well-suited to uses where high capacities are wanted (high-energy application). An in-principle disadvantage of the connection within the cell via the power outlet tabs is the comparatively high internal resistance, which reduces the charging and discharging rates. In addition, it increases the manufacturing outlay.

In the light of this prior art, it is an object of the present invention to provide a battery of the generic type mentioned at the outset which has a lower internal resistance and is therefore suitable for applications which require rapid charging or discharging (high-power application).

The object is achieved by at least one flat bimetal which is made of copper and aluminum and is coated on the copper side with anodically active material and on the aluminum side with cathodically active material and is arranged within one of the cell housings in such a way that it extends parallel to the poles of the cell housing and is joined to the frame of the cell housing so as to form an ionic seal and in this way divides the cell housing into at least two electrochemical cells connected in series.

The invention thus provides a battery having a plurality of intrinsically closed, essentially cuboidal cell housings in which in each case one side face is configured at least partly as negative pole and the opposite side face is configured at least partly as positive pole, where the cell housings are in juxtaposition pole to pole and extend between a positive contact and a negative contact and the cell housings are bounded in each case by an electrically nonconductive, mechanically supporting frame, wherein at least one flat bimetal which is made of copper and aluminum and is coated on the copper side with anodically active material and on the aluminum side with cathodically active material and extends within one of the cell housings parallel to the poles thereof and is joined to the frame of the cell housing so as to form an ionic seal and in such a way that the cell housing is divided into at least two electrochemical cells connected in series.

A basic concept of the present invention is to provide not only one electrochemical cell but at least two electrochemical cells connected in series within the cell housing unit. According to the invention, electrical connection is effected via the bimetal which simultaneously serves as current collector for an anode and for a cathode. Since the bimetal is, according to the invention, joined to the frame so as to form an ionic seal, i.e. electrolytes on the two sides of the bimetal are not in contact, with one another no ion exchange beyond the bimetal is able to occur. Only electrons migrate through the bimetal and in this way create the closed electric circuit required for the connection in series.

The advantage of this arrangement is that the current can flow over the entire area of the bimetal between the electrodes connected in series, as a result of which the internal resistance decreases. The charging and discharging rate is increased thereby, and, in addition, less waste heat has to be removed from the battery. Power outlet tabs within the cell housing are also dispensed with, which simplifies manufacture of the cell housing and makes it more advantageous.

Although the capacity of an individual cell housing according to the invention is, for a given volume, lower than in the case of the cell housing described in the prior art, in the case of a high-power application this is unimportant. Here, it is instead advantageous that the voltage between the poles of a single cell housing is at least twice as great as in the prior art for identical active materials.

Overall, the invention brings the structural advantages of the known high-energy battery to a high-power battery.

The negative pole of the cell housing is advantageously formed by a sheet-like copper body coated on the inside with anodically active material; the positive pole of the cell housing should correspondingly be formed by a sheet-like aluminum body coated on the inside with cathodically active material. In this way, the cell housing is particularly compact and its internal resistance is reduced further.

If the poles are coated on their insides with active material, it is possible for active material applied to the bimetal to form an electrochemical cell with counter-active material applied to a pole within the cell housing. In this way, the cell housing is particularly compact.

It is also possible to place two or more bimetals within the frame and in this way divide the cell housing into three or more electrochemical cells. For this purpose, a second flat bimetal which is made of copper and aluminum and is coated on the copper side with anodically active material and on the aluminum side with cathodically active material and extends parallel to the first bimetal within the cell housing and is joined to the frame of the cell housing so as to form an ionic seal and in such a way that the cell housing is divided into at least three electrochemical cells connected in series, where active material applied to the first bimetal forms an electrochemical cell with counter-active material applied to the second bimetal.

A particular embodiment of the invention provides for the cell housings to be clamped by means of at least one clamping means going around the frames of the cell housings to form a stack. The clamping forces are then transmitted directly between the clamping means and the frames of the cell housings. This forms a mechanically very stable battery having good contact between the poles of the cell housings.

The cell chemistry of the battery is preferably based on lithium ions. It is possible to use the customary active materials for this purpose. These are for the anodically active material, graphites; amorphous carbons; lithium storage metals and Li alloys, including nanocrystalline or amorphous silicon and also silicon-carbon composites, tin, aluminum and antimony; and Li₄Ti₅O₁₂ or mixtures thereof.

A particularly elegant embodiment of the invention can be achieved by the use of a lithium-titanium-containing anode material (known as LTO): when Li titanate (Li₄Ti₅O₁₂) is used an anode material, the bimetal can be omitted and a “monometal” composed of aluminum, i.e. a pure aluminum foil, can be used instead. The titanate can, owing to its high potential as anode material, also be applied to aluminum foil. The aluminum monometal is then suitable as support material both for the anode and for the cathode and can thus also be used as separating layer. Thanks to the LTO anode, the aluminum monometal simplifies the cell once more, a transition between materials is dispensed with, the internal resistance is potentially reduced further and the cell becomes cheaper. Otherwise, the battery has exactly the same structure as in the case of the bimetal.

The invention thus also provides a battery having a plurality of intrinsically closed, essentially cuboidal cell housings in which in each case one side face is configured at least partly as negative pole and the opposite side face is configured at least partly as positive pole, where the cell housings are in juxtaposition pole to pole and extend between a positive contact and a negative contact and the cell housings are bounded in each case by an electrically nonconductive, mechanically supporting frame, and in which at least one flat monometal which is made of aluminum and is coated on one side with an anodically active material containing lithium titanate and on the other side with a cathodically active material and extends within one of the cell housings parallel to the poles thereof and is joined to the frame of the cell housing so as to form an ionic seal and in such a way that the cell housing is divided into at least two electrochemical cells connected in series.

The cathode material for the monometal cell and the bimetal cell can be chosen freely; in the case of the monometal cell, the anode material alone is fixed as Li titanate. Accordingly, in both embodiments it is possible to use the following as cathodically active material:

lithium metal oxides of the type LiMₓO₂, including LiCoO₂; LiNiO₂; LiNi₁₋ₓCoₓO₂; LiNi_{0.85}Co_{0.1}Al₀₀₅O₂; Li₁₊ₓ(Ni_{y}Co_{1-2y}Mn_{y})₁₋ₓO₂, 0≦x≦0.17, 0≦y≦0.5; doped or undoped LiMn₂O₄ spinels; and doped or undoped lithium metal phosphates LiMPO₄, including LiFePO₄, LiMnPO₄, LiCoPO₄, LiVPO₄; and conversion materials such as iron(III) fluoride (FeF₃) or mixtures thereof.

The abovementioned active materials are admixed in a manner known per se with any conductivity additives and a bonding agent and applied to the pole bodies or to the bimetal.

The bimetal is preferably produced in a manner known per se from an aluminum foil and a copper foil by cold welding the two foils. For this purpose, the foils are firstly provided with a high surface quality (polished) on the surface which is later to form the interface and then pressed onto one another without particular application of heat but under a high pressure. The close proximity of the foils and their low roughness allows adhesive surface forces to act at the interface and hold the foils together. The production of Cu/Al bimetal foil is in itself prior art.

The invention also provides a cell housing of a battery according to the invention.

The invention is illustrated below by means of an example and with the aid of the drawings. The drawings schematically show:

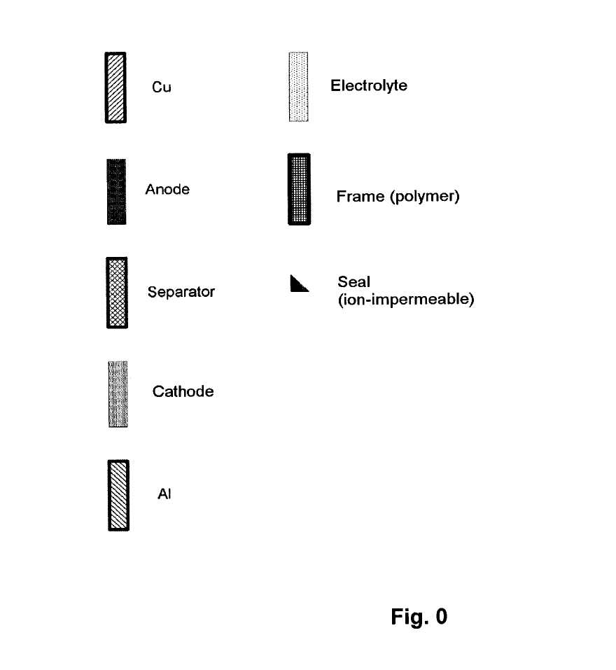

FIG. 0: legends;

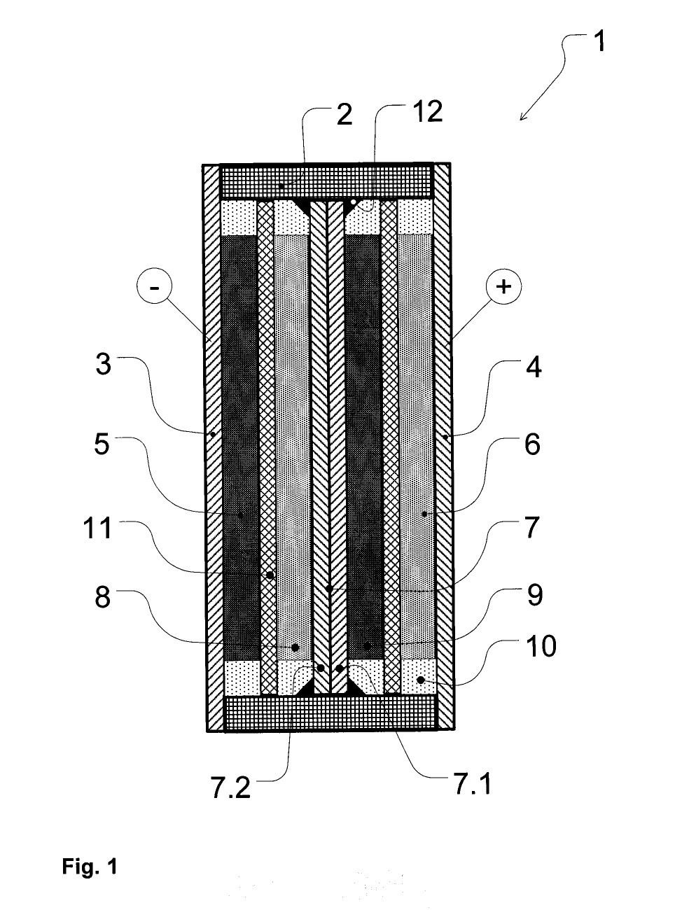

FIG. 1: cell housing in cross section, containing two electrochemical cells;

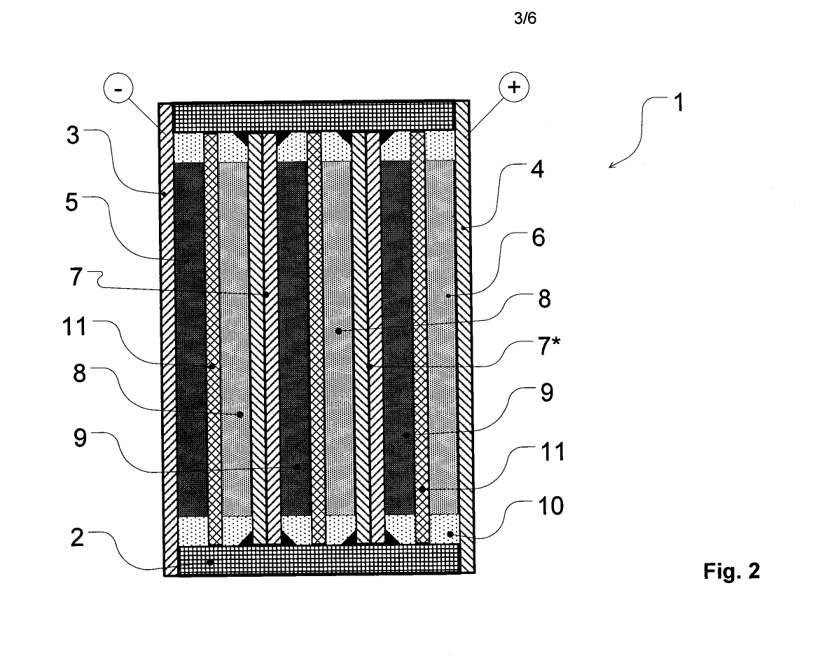

FIG. 2: cell housing in cross section, containing three electrochemical cells;

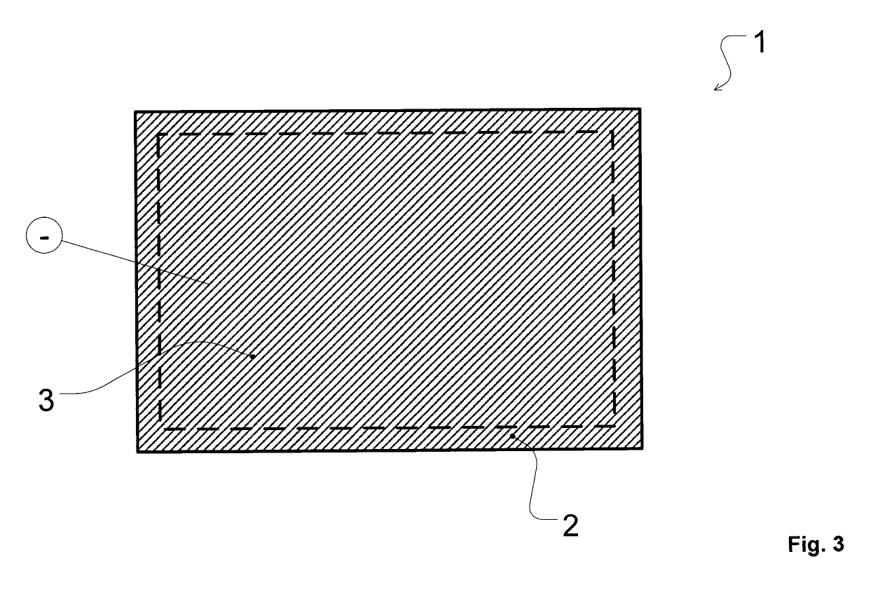

FIG. 3: cell housing in plan view;

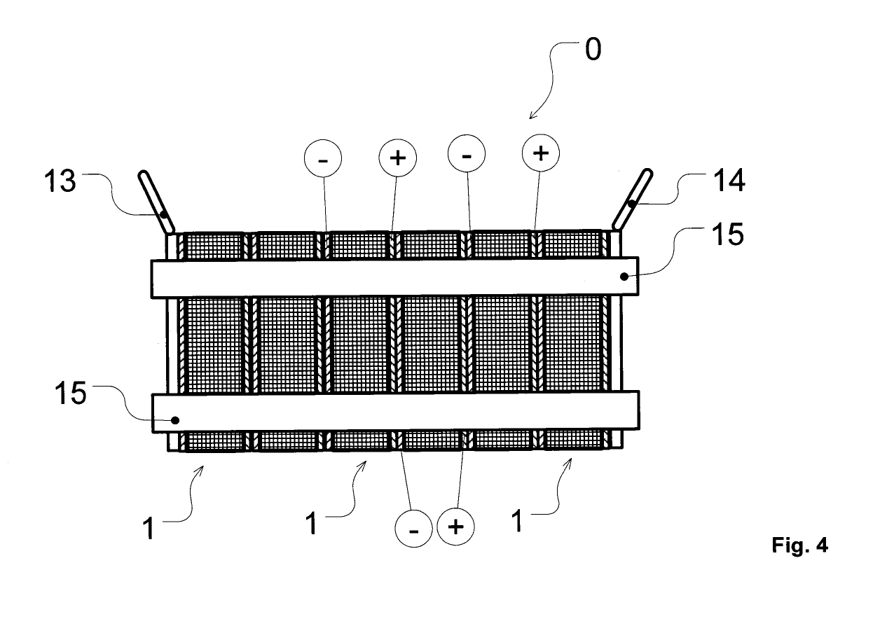

FIG. 4: battery, side elevation;

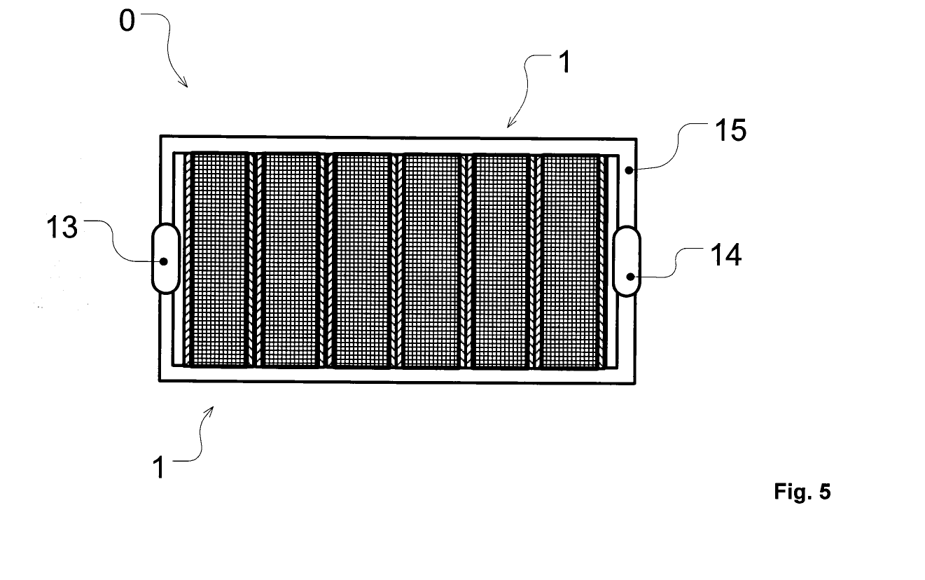

FIG. 5: battery, plan view.

FIG. 1 shows a cell housing 1 of a battery 0 according to the invention in it simplest form. The cell housing 1 is essentially cuboidal and flat; as can be seen, in particular, from a combination of the cross section in FIG. 1 with the plan view in FIG. 3. In the cross section the thickness of the cell housing 1 is exaggerated; in practice, the cell housing 1 can be flatter.

The load-bearing part of the cell housing 1 is a frame 2 made of nonconductive polymer. The frame 2 is closed on one face by a copper body 3 and on the other face by an aluminum body 4. Both metal bodies 3, 4 are flat foils which form opposite side faces of the cuboidal cell housing 1. The copper body 3 serves as negative pole (−) of the cell housing; the aluminum body 4 serves as positive pole (+).

The copper body 3 is coated on its inside with anodically active material 5; the aluminum body 4, on the other hand, is coated with cathodically active material 6. The metal bodies 3, 4 thus also serve as current collectors for the two electrodes. A short circuit between the metal bodies 3, 4 is prevented by the frame 1 which in this respect also serves as insulator.

The two active materials 5, 6 are mixtures known per se for secondary lithium ion cells; namely graphites; amorphous carbons; lithium storage metals and alloys, including nanocrystalline or amorphous silicon and silicon-carbon composites, tin, aluminum and antinomy; and Li₄Ti₅O₁₂ or mixtures thereof for the anode and lithium metal oxides of the type LiMₓO₂, including LiCoO₂; LiNiO₂; LiNi₁₋ₓCoₓ(O₂; LiNi_{0.86}Co_{0.1}Al_{0.05}O₂; Li₁₊ₓ(Ni_{y}Co_{1-2y}Mn_{y})₁₋ₓO₂, 0≦x≦0.17, 0≦y≦0.5; doped or undoped LiMn₂O₄ spinels; and doped or undoped lithium metal phosphates LiMPO₄, including LiFePO₄, LiMnPO₄, LiCoPO₄, LiVPO₄; and conversion materials such as iron(III) fluoride (FeF₃) or mixtures thereof for the cathode.

The active materials 5, 6 on the two metal bodies 3, 4 together do not form an electrochemical cell but only form such a cell together with respective counter-active materials 6, 5 on a bimetal 7 inserted approximately centrally in the cell housing 1.

The bimetal 7 is composed of a copper foil 7.1 and an aluminum foil 7.2. For this purpose, the two foils 7.1, 7.2 are provided on the sides facing one another with a high surface quality (very low roughness as a result of polishing or the like) and pressed together under a high pressure, so that cold welding occurs and the foils 7.1, 7.2 are joined virtually undetachably to form a bimetal 7.

The flat bimetal 7 extends parallel to the two poles (+), (−) approximately centrally through the cell housing 1 and divides the latter into two electrochemical cells. The bimetal functions as an electrode for each of the two electrochemical cells, i.e. as cathode for the cell facing the negative pole (−) and as anode for the cell facing the positive pole (+). For this purpose, the aluminum foil 7.2 of the bimetal 7 which faces the negative pole (−) is coated with cathodically active material 8; the copper foil 7.1 of the bimetal 7 which faces the positive pole (+) is correspondingly coated with anodically active material 9.

The cell housing 1 is filled with electrolyte 10 on both sides of the bimetal 7. As electrolyte, it is possible to use, in a manner known per se, a solution of, for example, LiPF₆, LiBF₄, LiClO₄, LiAsF₆, LiCF₃SO₃, LiClO₄, lithium bisoxalatoborate (Libob) and/or lithium bis(trifluoromethylsulfonyl)amide (BTA, LiN(SO₂CF₃)₂) in ethylene carbonate (EC), dimethylcarbonate (DC), propylene carbonate (PC), methyl propyl carbonate (PMC), butylene carbonate (BC), diethyl carbonate (DEC), γ-butyrolactone (γ-BL), SOCl₂ and/or SO₂. The electrolyte solutions usually contain from 0.1 to 5 mol/l, particularly preferably from 0.5 to 2 mol/l of electrolyte salt.

Electrolyte 10 in each case fills the space between the bimetal 7 and the metal bodies 3, 4, in which in each case an anode and a cathode of the metal body or the bimetal is arranged, so that an electrochemical cell is formed on each side of the bimetal 7. The electrodes are in each case separated from one another by an iron-permeable but electrically insulating separator 11 in order to avoid a short circuit between the electrodes. The bimetal 7 is installed on the frame 2 and ionically sealed in the contact region by means of a seal 12 so that no iron bridge over the bimetal is formed. The two electrochemical cells comprising anode 5/cathode 8 and anode 9 and cathode 6 are thus separated from one another ionically but there is a closed electric circuit via the bimetal, so that two electrochemical cells are connected in series between the two poles (+), (−) of the cell housing 1.

According to the invention, it is also possible to divide the cell housing into three electrochemical cells by means of two bimetals. The corresponding layer arrangement with a second bimetal 7* is shown in FIG. 2. Of course, the number of cells per cell housing can also be increased further by the use of more than two bimetals.

FIGS. 4 and 5 show how a plurality of cell housings 1 can be assembled to form a battery 0. For this purpose, the cell housings 1 (six in number in the example depicted) are stacked with the opposite poles in juxtaposition, in each case (+) next to (−) between a negative contact 13 and a positive contact 14 and clamped by means of clamping means 15. A series connection of the individual cell housings is formed in this way. When the cell chemistry is based on 3.6 V lithium ion technology and each cell housing 1 contains two electrochemical cells as shown in FIG. 1 the total battery voltage between contacts 13, 14 is 43.2 V. To increase the capacity, two such batteries 0 having the same voltage can be connected in parallel.

The external and internal forces acting on the battery 0 are taken up by the clamping means 15 and the frame 2 of the individual cell housings 1. The mechanically sensitive electrodes and the separator are kept free of the action of damaging force in this way.

The battery and the cell housings have been depicted purely schematically. They can be appropriately configured as shown in WO 2009/103527 A1. The latter is incorporated by reference into the present text in respect of the disclosure content. Furthermore, the battery can be provided with functional units known per se, e.g. a cooling device and/or battery management system.

### LIST OF REFERENCE NUMERALS

0 Battery
1 Cell housing
2 Frame
3 Copper body
4 Aluminum body
5 Anodically active material on Cu body
6 Cathodically active material on Al body
7 Bimetal
71 Cu foil of the bimetal
72 Al foil of the bimetal
7* Second bimetal
8 Cathodically active material on bimetal
9 Anodically active material on bimetal
10 Electrolyte
11 Separator
12 Seal
13 Negative contact
14 Positive contact
15 Clamping means
(−) Negative pole
(+) Positive pole

1. A battery comprising
a plurality of intrinsically closed, essentially cuboidal cell housings, wherein
in each cell housing a first side face is configured at least partly as a negative pole and a second side face opposite to the first side face is configured at least partly as a positive pole,
the plurality of cell housings are in juxtaposition from the negative pole to the positive pole and extend between a positive contact and a negative contact,
the plurality of cell housings are bounded by an electrically nonconductive, mechanically supporting frame,
a first flat bimetal comprises a copper side and an aluminum side, and is coated on the copper side with an anodically active material and on the aluminum side with a cathodically active material, and
the first flat bimetal extends within each cell housing parallel to the negative and positive poles thereof, and is joined to the frame so as to form an ionic seal and in such a way that each cell housing is divided into two electrochemical cells connected in series.

2. The battery of claim 1,
wherein
the negative pole of each cell housing comprises a sheet-like copper body coated with an anodically active material.

3. The battery of claim 1,
wherein
the positive pole of each cell housing comprises a sheet-like aluminum body coated with a cathodically active material.

4. The battery of claim 2,
wherein
the cathodically active material applied to the bimetal forms an electrochemical cell with the anodically active material applied to the negative pole within each cell housing.

5. The battery of claim 1,
further comprising
a second flat bimetal, which comprises a copper side and an aluminum side and is coated on the copper side with an anodically active material and on the aluminum side with a cathodically active material;
the second flat bimetal extends within each cell housing parallel to the first bimetal and is joined to the frame of each cell housing so as to form an ionic seal and in such a way that each cell housing is divided into three electrochemical cells connected in series.

6. The battery of claim 1,
wherein
the plurality of cell housings are clamped to form a stack.

7. The battery of claim 1,
wherein
the anodically active material is selected from the group consisting of graphite; amorphous carbon; a lithium storage metal or alloy; nanocrystalline or amorphous silicon; a silicon-carbon composite; tin; aluminum; antimony; Li₄Ti₅O₁₂; and any mixture thereof.

8. The battery of claim 1,
wherein
the cathodically active material is selected from the group consisting of a lithium metal oxide of formula LiMₓO₂, wherein 0≦x≦0.17; a doped or undoped LiMn₂O₄ spinel; a doped or undoped lithium metal phosphate LiMPO₄; a conversion material; and any mixture thereof.

9. The battery of claim 1,
wherein
the bimetal is a copper foil cold-welded to an aluminum foil.

10. A battery comprising
a plurality of closed, essentially cuboidal cell housings wherein
in each cell housing a first side face is configured at least partly as a negative pole and a second side face opposite to the first side face is configured at least partly as a positive pole,
the plurality of cell housings are in juxtaposition from the negative pole to the positive pole and extend between a positive contact and a negative contact,
the plurality of cell housings are bounded by an electrically nonconductive, mechanically supporting frame,
a flat monometal comprises aluminum and is coated on one side with an anodically active material comprising lithium titanate and on the other side with a cathodically active material, and
the flat monometal extends within each cell housing parallel to the positive and negative poles thereof, and is joined to the frame so as to form an ionic seal and in such a way that each cell housing is divided into two electrochemical cells connected in series.

11. (canceled)

12. The battery of claim 3,
wherein the anodically active material applied to the bimetal forms an electrochemical cell with the cathodically active material applied to the positive pole within each cell housing.

13. The battery of claim 8,
wherein the lithium metal oxide is of formula Li₁₊ₓ(Ni_{y}Co_{1-2y}Mn_{y})₁₋ₓO₂, wherein
0≦x≦0.17, and
0≦y≦0.5.

14. The battery of claim 8, wherein
the lithium metal oxide is LiCoO₂, LiNiO₂, LiNi_{0.85}Co_{0.1}Al_{0.05}O₂ or LiNi₁₋ₓCoₓO₂, wherein 0≦x≦0.17;
the lithium metal phosphate is LiFePO₄, LiMnPO₄, LiCoPO₄, or LiVPO₄; and
the conversion material is iron(III) fluoride (FeF₃).

15. A cell housing comprising:
a first side face configured at least partly as a negative pole and a second side face opposite to the first side face configured at least partly as a positive pole,
an electrically nonconductive, mechanically supporting frame, and
a flat bimetal, which comprises a copper side and an aluminum side and is coated on the copper side with an anodically active material and on the aluminum side with a cathodically active material, wherein
the flat bimetal extends within the cell housing parallel to the negative and positive poles thereof, and is joined to the frame so as to form an ionic seal and in such a way that the cell housing is divided into two electrochemical cells connected in series.

16. The cell housing of claim 15, wherein the cell housing further comprises a second flat bimetal, which divides the cell housing into three electromechanical cells.

17. The cell housing of claim 15, wherein the negative pole comprises a sheet-like copper body coated with an anodically active material.

18. The cell housing of claim 15, wherein the positive pole comprises a sheet-like aluminum body coated with a cathodically active maerial.

19. The cell housing of claim 15, wherein the anodically active material is selected from the group consisting of graphite; amorphous carbon; a lithium storage metal or alloy; nanocrystalline or amorphous silicon; a silicon-carbon composite; tin; aluminum; antimony; Li₄Ti₅O₁₂; and any mixture thereof.

20. The cell housing of claim 15, wherein the cathodically active material is selected from the group consisting of a lithium metal oxide of formula LiMₓO₂, wherein 0≦x≦0.17; a doped or undoped LiMn₂O₄ spinel; a doped or undoped lithium metal phosphate LiMPO₄; a conversion material; and any mixture thereof.
